(19) United States
(12) Patent Application Publication
(10) Pub. No.: US 2013/0234876 A1
(43) Pub. Date: Sep. 12, 2013

(54) REMOTE CONTROL POWER UNITS

(71) Applicant: William Huang, Sanchung City (TW)

(72) Inventor: William Huang, Sanchung City (TW)

(73) Assignee: INTEK AMERICA, INC., Rancho Dominguez, CA (US)

(21) Appl. No.: 13/989,770

(22) PCT Filed: Nov. 28, 2011
(86) PCT No.: PCT/US2011/062251

§ 371 Date: May 24, 2013

Related U.S. Application Data
(60) Provisional application No. 61/417,360, filed on Nov. 26, 2010.

(51) Int. Cl. G08C 19/28

(52) U.S. Cl. CPC G08C 19/28
USPC 341/176

(57) ABSTRACT

A remote controlled switch system has a hand-held remote control for turning power to a controllable switch on and off by radio waves. Each remote control unit contains at least one unique identifying code and can be linked to one or more separate controllable switches. The number of controllable switches that can be controlled by a single hand-held remote control is essentially limitless.

The present application is based on and claims the priority and benefit of U.S. application Ser. No. 61/417360, filed on 26 Nov. 2011.

### DESCRIPTION OF THE INVENTION

The modern home boasts an ever increasing number of more or less complicated electronic and electrical devices including, to name a few, lamps, personal computers, printers, televisions, radios, sound systems, game counsels, paper shredders, telephone systems and microwave ovens. A problem with many electronic and electrical devices is that they are never completely turned off. Even when the unit is ostensibly “turned off,” it is actually in a standby mode and continues to draw electric power. In some cases this continuously drawn power is used to operate a built-in clock or to maintain the device in a state for rapid power-on. Gradually the public has come to appreciate that this “phantom” or “vampire” load caused by standby power consumption is an expensive waste of electrical power that contributes to the increase of atmospheric carbon dioxide. Another source of wasted electricity comes from devices that do not have a phantom load problem—that is, these are devices that draw no power when they are switched off. However, it is often the case that the devices are so inconveniently located that it is difficult, if not impossible, to reach the on-off switch. Therefore, the devices are permanently left on.

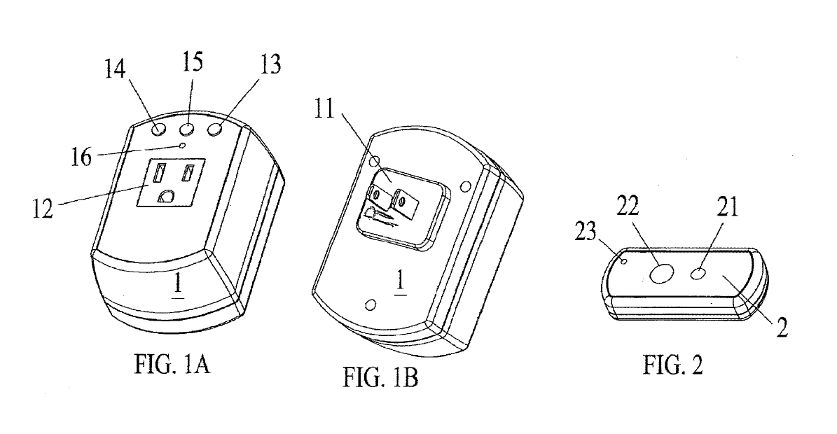

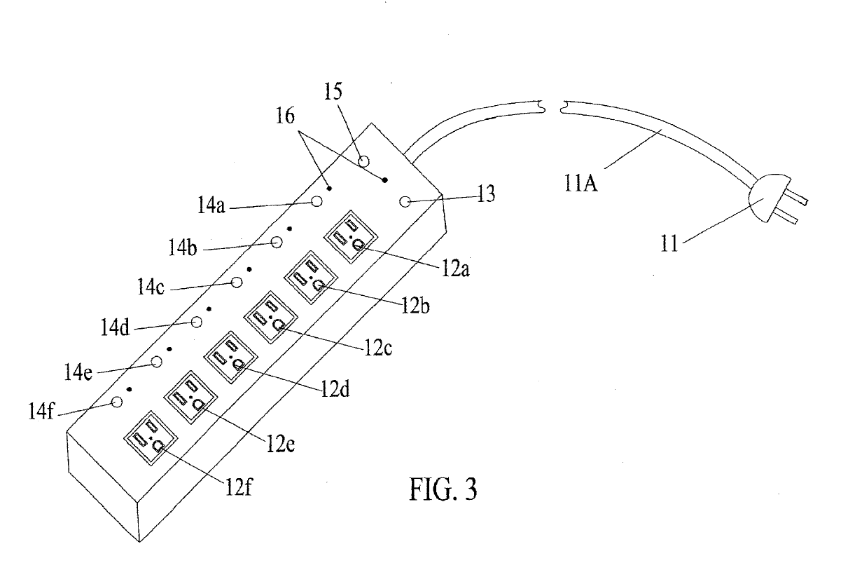

One solution to the above-mentioned problem is to plug the problematic devices into a power strip that has either a master on-off switch (that shuts off the electric power to all outlets on the power strip) or individual switches that allow each outlet (and hence each device) to be individually powered on and off. Provided that the power strip is readily accessible all of the plugged in devices can be easily turned on and off. Unfortunately, this approach is not always convenient. Suppose that one desires to turn on a lamp on the opposite side of a darkened room. Even if the power strip switch is readily accessible, it may be difficult or dangerous to cross the darkened room to turn on the light. Similarly, one may wish to turn on a television or turn off a light while in bed. Clearly this is inconvenient when the power strip is located on the opposite side of the room. As a result there has been a tremendous increase in the availability of remote control power outlet switches. Such switches are usually operable by a small handheld remote as shown in FIG. 2. The switch can either be in a power strip as shown in FIG. 3, in a unit or module that plugs into a wall outlet as shown in FIG. 1 and into which an appliance to be switched or an ordinary power strip (thereby permitting control of multiple appliances) is plugged. Or the switch can be embedded within the wall outlet itself. The remote can communicate with the switch either by sound or electromagnetic energy. Generally, electromagnetic radiation in the “radio” frequency range (about 30 kHz to 300 GHz) is preferred because such radiation may be able to penetrate solid objects so as to control units behind furniture or in another room. Radio frequency in the 433 MHz region is preferred in certain countries such as the United States. Power strips or outlets can also be controlled by electromagnetic signals transmitted to them through the electrical power delivery wires of the building. The present invention is primarily directed to a system where the remote control communicates directly with the power strip or power outlet by electromagnetic radiation transmitted through the atmosphere.

The problem that vexes remote power switches of this type is how to coordinate the remote control and the switches it controls. One method is to have a mechanical code selecting switch (or switches) on both the outlet and the remote. By setting the remote and the switch to the same code, communication between the remote and the switch is enabled. The advantage of such an approach is that an essentially unlimited number of switch units can be set to the same code and controlled by a single remote. The drawback to this approach is that setting the code switch can be difficult, and a mechanical code switch is yet another point of potential system failure. Furthermore, a code switch and/or switches provide(s) a relatively limited number of codes (usually fewer than about one-hundred). This means that there is a significant chance for a neighbor to be using a remote with the same code which will result in unwanted interference.

More recently digital technology has made it possible to provide remotes having one of a large number of preset codes. For example, if a digital identification code is 20 bits long, it can provide over one million different codes. That is to say, over one million different remote units can be supplied. This makes the likelihood of a neighbor having an interfering remote extremely small. If the remote is provided already “flashed” with one of a plurality of identifying codes, the problem of setting code switches and the like is eliminated. However, there remains the problem of associating (“linking”) a given remote to a given power switch. One prior art device accomplishes this by rendering the switch “receptive” either when it is first plugged into a power source and/or when a given button or combination of buttons is pressed. Once the switch is “receptive” it “listens” for a transmission from a remote for a preset period of time. When it “hears” a transmission or when the preset time elapses, the unit returns to its normal “non-receptive” mode. In this type of system the remote is capable of transmitting a number of digitally coded commands. Each command contains the identification code of the particular remote. When the switch is “receptive” and “listens” for that code, the switch records the code in its onboard memory. Thereafter, the switch will respond only to commands that contain the recorded code. Those of ordinary skill in the art will immediately understand a plurality of hardware and software solutions to the problem of comparing incoming digital radio commands to a code stored in memory so that only transmissions that contain the stored code will be acted upon. It is preferred to use either “flash” or battery backed memory to store the code. Otherwise, each time the switch is unplugged from the power line, it will lose its association/linking to a given remote. A problem with this system is possibility that another signal (not from the remote) will be received by the switch while it is receptive. The possibility is not all that small because of the large number of devices that use a given frequency such as 433 MHz. This problem is not necessarily fatal because the linking process can be repeated until the desired results are obtained. However, this can be confusing and frustrating for a user.

The linking problem is solved in the present invention by equipping both the remote and the switch with a button or combination of buttons that initiate the linking process. Activating the linking button or linking button combination on the switch renders the switch “receptive.” By “button combination” is meant the pushing of multiple buttons simultaneously (or in a predetermined sequence). For example, if both an “ON” button and an “OFF” button are present, pressing both buttons simultaneously could act as a linking button. Pressing the linking button or the linking button combination on the remote causes the remote to send a special linking command. When the receptive switch hears this command it stores the associated identification code for the remote in its memory. The requirement for the presence of a linking command makes it highly unlikely that data from a stray transmission will be inadvertently stored as a remote code. It will be further appreciated that limiting the receptive period of the switch to the time that the linking button or linking button combination is actually pressed will further reduce the possibility of storing a stray code.

Such a system can allow a single remote to be linked to essentially any number of remote switches. That is, a very large system can be easily constructed. It is possible to have linked switches spread over a very large area. In such a case, a given switch will respond only when the remote is brought into range. It will also be appreciated that such a system can easily be modified so that a given switch can respond to more than one unique remote. For example, if the switch is provided with four as opposed to a single on board memory location, the switch can be linked to four different unique remotes. There is no real limit to the number of remotes, but a practical limit is probably between four and eight simply because of the problem of having a pile of similar remotes lying around. This can be alleviated by actually providing a remote with a plurality of buttons with each button corresponding to a unique code (that is, acting like a separate remote). This would allow a simple hand held remote to control eight or even more different switches or groups of switches.

One of ordinary skill in the art will appreciate that a great variety of digital message structures can be used to implement the above-described system. The number and content/length of the digital commands can be varied widely. The number of bits used to encode the identity of the remote can vary. Different modulation and checksum schemes can be used to avoid interference. One possible 30 bit message scheme is as follows: Start-bit (1 bit)+Remote ID address bit (20 bits)+Data bit (8 bits, for ON, OFF or Link)+Sync End (1 bit). The remote 2 shown in FIG. 2 includes an LED 23 to indicate operation, a command button 22 to send either an ON command or an OFF command (upon sequential presses of the button 22) and a linking button 21 for sending a Link command. Those of ordinary skill in the art will appreciate that 8 bits of data allow for a much more complex command language than “ON”, “OFF” and “Link,” if desired. Furthermore, it is a simple modification to provide both an OFF and an ON button. FIG. 1 shows a single outlet 1 for use with the remote 2. The outlet 1 has an ON button 15 and an LED 16 that glows when the outlet 12 has been switched on. An OFF button 14 is provided to switch the outlet power off; linking button 13 puts the outlet into the receptive mode as discussed above. FIG. 3 shows a power strip where each outlet 12 can be controlled individually. If the linking button 13 and the ON button 15 are pressed simultaneously, a single remote can then be linked to control all of the outlets 12a . . . f. If the linking button 13 and one of the outlet buttons 14a . . . f are pressed, then a given remote can be linked to the corresponding outlet. When an outlet is turned on by a remote, the corresponding LED 16 glows. The outlet can be manually turned off by pressing the corresponding outlet OFF button 14a . . . f. If an outlet is off, pressing both the ON button 15 and one of the outlet buttons 14 will turn the corresponding outlet on. Alternatively, separate OFF and ON buttons can be provided for each outlet.

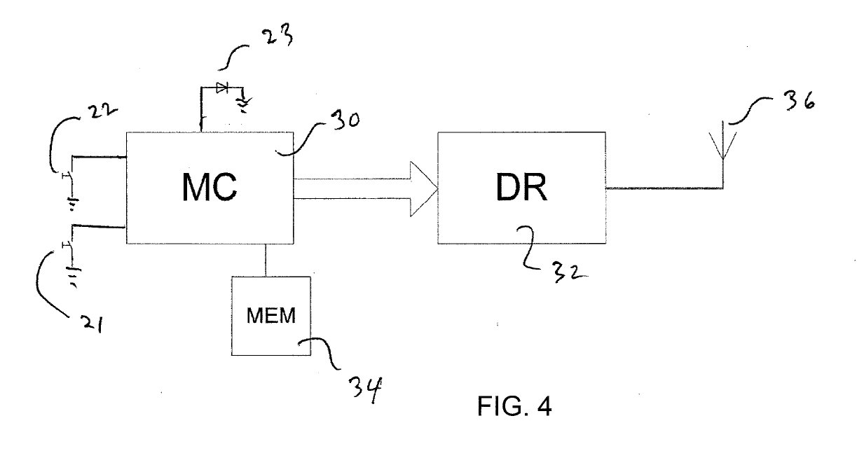

FIG. 4 shows a block diagram of a remote. A micro-controller 30 is provided with a memory 34 to hold the unique identification code for the remote. In actual practice, the memory 34 would likely be part of the micro-controller 30 and not a discrete element. The micro-controller 30 received input from a number of switches such as ON/OFF button 22 and linking button 21. The micro-controller 30 controls the on/off state of LED 23. The micro-controller 30 also communicates with a digital radio 32 which converts commands received from the microcontroller into digital radio signals which are output through an antenna 36. Those of ordinary skill in the art will appreciate that this block diagram can be implemented as one or more integrated circuit chips and may also include various other integrated circuit chips and discrete electronic components.

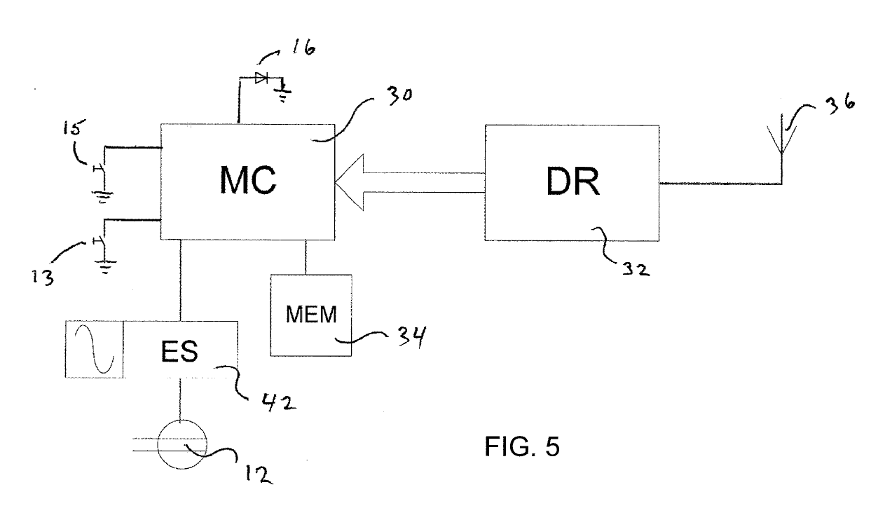

FIG. 5 shows a block diagram of a switch that is controlled by the remote of FIG. 4. A micro-controller 30 is provided with a memory 34 to hold the unique identification code received from the remote during the linking process. In actual practice, the memory 34 could be part of the micro-controller 30 and not a discrete element. The micro-controller 30 received input from a number of switches such as ON button 15 and an OFF button 14 and linking button 13. The micro-controller 30 controls the on/off state of LED 16 as well as the state of an electronic switch 42 that controls the power going to the outlet 12. The micro-controller 30 also communicates with a digital radio 32 which receives digital radio signals from the remote through an antenna 36 and outputs digital data to the microcontroller. Those of ordinary skill in the art will appreciate that this block diagram can be implemented as one or more integrated circuit chips and may also include various other integrated circuit chips and discrete electronic components. The electronic switch 42 may be some type of mechanical relay or may be a solid state relay (SSR) such as dual MOSFETs (metal-oxide-semiconductor field-effect transistor).

What is claimed is:

1. A remote control switching system comprising:
a remote control unit comprising:
at least one stored unique digital remote unit identification code;
means for transmitting said code and a linking command;
means for transmitting said code and an ON command; and
means for transmitting said code and an OFF command; and
a controllable switch comprising:
means for controlling electrical power of an outlet;
means for receiving said identification code and said commands transmitted by the remote control unit;
means for storing said identification code when said code is accompanied by a linking command only when a linking control on the controllable switch is activated thereby rendering the controllable switch receptive; and
means for comparing the digital remote unit identification code in a given received transmission to the stored code and responding to accompanying commands when the received digital remote unit identification code matches the stored code whereby the electrical power to the outlet is turned off and on in response to commands from the remote control unit.

2. The remote control switching system according to claim 1, further comprising means for the remote control unit to transmit additional commands and further comprising means for the controllable switch to receive and respond to the additional commands.

3. The remote control switching system according to claim 1, wherein the means for transmitting the unique digital remote unit identification code and the linking code comprises simultaneously activating at least two controls on the remote control unit.

4. The remote control switching system according to claim 1, wherein the controllable switch is rendered receptive by activating at least one control on the controllable switch.

5. The remote control switching system according to claim 1, wherein the controllable switch is rendered receptive by simultaneously activating at least two controls on the controllable switch.

6. The remote control switching system according to claim 1, wherein the remote control unit unique stores more than one unique digital remote unit identification code and contains means for selecting which of said codes is transmitted.

7. The remote control switching system according to claim 6, wherein the controllable switch is capable of storing at least two unique identification codes so that the controllable switch will respond to at least two different remote control units.
